(19) United States
(12) Patent Application Publication
(10) Pub. No.: US 2006/0085253 A1
(43) Pub. Date: Apr. 20, 2006

(54) Method and system to utilize a user network within a network-based commerce platform

(76) Inventors: Matthew Mengerink, San Jose, CA (US); Michel Weksler, Albany, CA (US); Bharathi Ramavarjula, San Jose, CA (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 10/968,197

(22) Filed: Oct. 18, 2004

(51) Int. Cl. G07G 1/14; G07G 1/00; G06Q 30/00

(52) U.S. Cl. 705/14; 705/26

(57) ABSTRACT

A method and a system to utilize a user network within a network-based commerce platform. For example, the method includes identifying a target group including at least one other user of the network-based commerce system based on at least one group association rule, the at least one group association rule being selected by a first user, communicating transaction information to the identified target group, and facilitating the transaction between at least one target user of the identified target group and the first user, wherein the first user and the identified target group have an existing relationship.

### FIELD OF THE INVENTION

Exemplary embodiments of present invention relate generally to the technical field of network-based commerce platforms and, in one exemplary embodiment, to methods and systems to utilize a user network within a network-based commerce platform.

### BACKGROUND OF THE INVENTION

Network-based commerce provides an easy and effective way to market, sell, and buy products, including goods and/or services. Such network-based commerce platforms require users to become members by joining and participating in their network-based commerce model. In other words, the members in aggregate form a community of buyers, sellers, shoppers, and often friends and family. However, these relationships within the community are not harvested and exposed to the users and are thus not available for targeted transaction activities, such as marketing, private auctions, and direct sales.

### SUMMARY OF THE INVENTION

According to one aspect of the present invention, there is provided a system to utilize a user network within a network-based commerce platform. In one exemplary embodiment, the system includes a group association rule module to identify a target group including at least one other user of the network-based commerce system, the identification being based on at least one group association rule selectable by a first user, a listing module to distribute transaction information to the identified target group, and a transaction module to facilitate the transaction between at least one target user of the identified target group and the first user, wherein the first user and the identified target group have an existing relationship.

### BRIEF DESCRIPTION OF THE DRAWINGS

The present invention is illustrated by way of example and not limitation in the figures of the accompanying drawings, in which like references indicate similar elements and in which:

FIG. 1 is a network diagram depicting a system, according to an exemplary embodiment of the invention, having a client-server architecture;

FIG. 2 is a block diagram illustrating multiple marketplace and payment applications that are provided as part of the network-based marketplace, according to an exemplary embodiment of the invention;

FIG. 3 is a high-level entity-relationship diagram, according to an exemplary embodiment of the invention, illustrating various tables that may be maintained within a database, and that are utilized by and support the marketplace and payment applications;

FIG. 4 illustrates an exemplary relationship diagram showing direct and indirect relationships between a first user and a target group of users;

FIG. 5A illustrates a user networking application that includes a user data module, according to an exemplary embodiment of the invention, for collecting additional user data;

FIG. 5B illustrates a listing creation application, which includes a group association rule module, a user networking module, and a listing module to generate a target group of users, the modules being according to an exemplary embodiment of the invention;

FIG. 5C illustrates a transaction application(s), which include(s) a transaction module, according to an exemplary embodiment of the invention, to facilitate transactions between users;

FIG. 6 is an interactive flowchart illustrating a process, according to an exemplary embodiment of the invention, of generating a target group associated with a network-based marketplace based upon at least one group association rule; and

FIG. 7 illustrates a diagrammatic representation of machine in the exemplary form of a computer system within which a set of instructions, for causing the machine to perform any one or more of the methodologies discussed herein, may be executed.

### DETAILED DESCRIPTION

A method and system to utilize a user network within a network-based commerce platform are described. In the following description, for purposes of explanation, numerous specific details are set forth in order to provide a thorough understanding of the present invention. It will be evident, however, to one skilled in the art that the present invention may be practiced without these specific details.

Platform Architecture

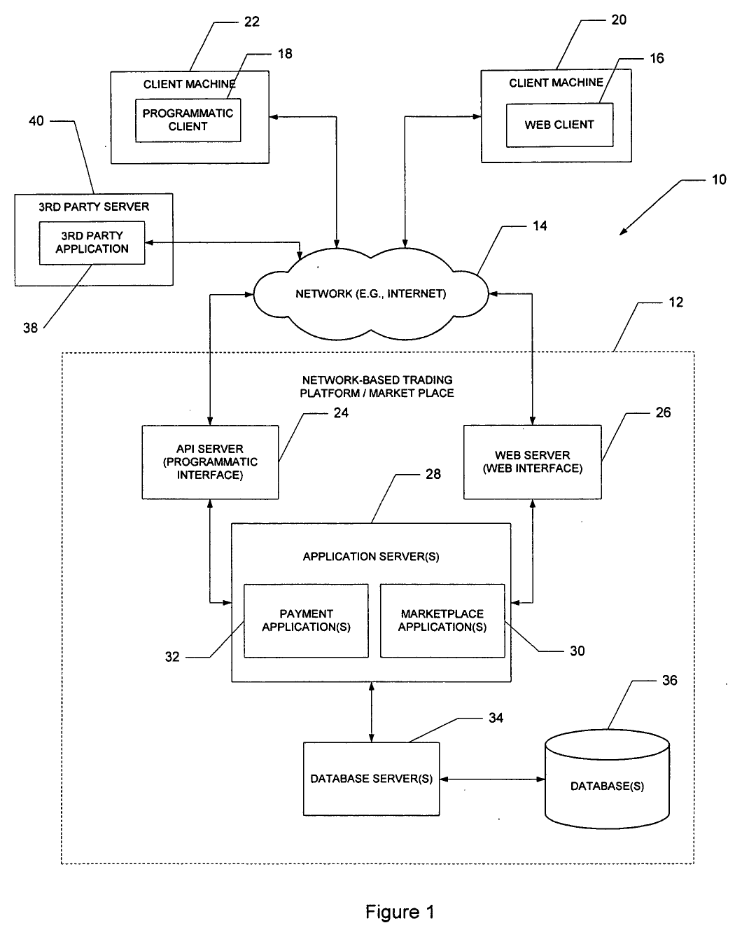

FIG. 1 is a network diagram depicting a trading/commerce system 10, according to one exemplary embodiment of the present invention, having a client-server architecture. A commerce platform, in the exemplary form of a network-based marketplace 12, provides server-side functionality, via a network 14 (e.g., the Internet) to one or more clients. The one or more clients may include users that utilize the trading/commerce system 10 and more specifically, the network-based marketplace 12, to facilitate transactions according user selected group association rules, according to one embodiment of the present invention.

FIG. 1 illustrates, for example, a web client 16 (e.g., a browser, such as the Internet Explorer browser developed by Microsoft Corporation of Redmond, Wash. State), and a programmatic client 18 executing on respective client machines 20 and 22.

Turning specifically to the network-based marketplace 12, an Application Program Interface (API) server 24 and a web server 26 are coupled to, and provide programmatic and web interfaces respectively to, one or more application servers 28. The application servers 28 host one or more marketplace applications 30 and payment applications 32. The application servers 28 are, in turn, shown to be coupled to one or more databases servers 34 that facilitate access to one or more databases 36.

The marketplace applications 30 provide a number of marketplace functions and services to users that access the marketplace 12. The payment applications 32 likewise provide a number of payment services and functions to users. The payment applications 30 may allow users to quantify for, and accumulate, value (e.g., in a commercial currency, such as the U.S. dollar, or a proprietary currency, such as “points”) in accounts, and then later to redeem the accumulated value for products (e.g., goods or services) that are made available via the marketplace applications 30. While the marketplace and payment applications 30 and 32 are shown in FIG. 1 to both form part of the network-based marketplace 12, it will be appreciated that, in alternative embodiments of the present invention, the payment applications 32 may form part of a payment service that is separate and distinct from the marketplace 12.

Further, while the system 10 shown in FIG. 1 employs a client-server architecture, the present invention is of course not limited to such an architecture, and could equally well find application in a distributed, or peer-to-peer, architecture system. The various marketplace and payment applications 30 and 32 could also be implemented as standalone software programs, which do not necessarily have networking capabilities.

The web client 16, it will be appreciated, accesses the various marketplace and payment applications 30 and 32 via the web interface supported by the web server 26. Similarly, the programmatic client 18 accesses the various services and functions provided by the marketplace and payment applications 30 and 32 via the programmatic interface provided by the API server 24. The programmatic client 18 may, for example, be a seller application (e.g., the TurboLister application developed by eBay Inc., of San Jose, Calif.) to enable sellers to author and manage listings on the marketplace 12 in an off-line manner, and to perform batch-mode communications between the programmatic client 18 and the network-based marketplace 12.

FIG. 1 also illustrates a third party application 38, executing on a third party server machine 40, as having programmatic access to the network-based marketplace 12 via the programmatic interface provided by the API server 24. For example, the third party application 38 may, utilizing information retrieved from the network-based marketplace 12, support one or more features or functions on a website hosted by the third party. The third party website may, for example, provide one or more promotional, marketplace or payment functions that are supported by the relevant applications of the network-based marketplace 12.

Marketplace Applications

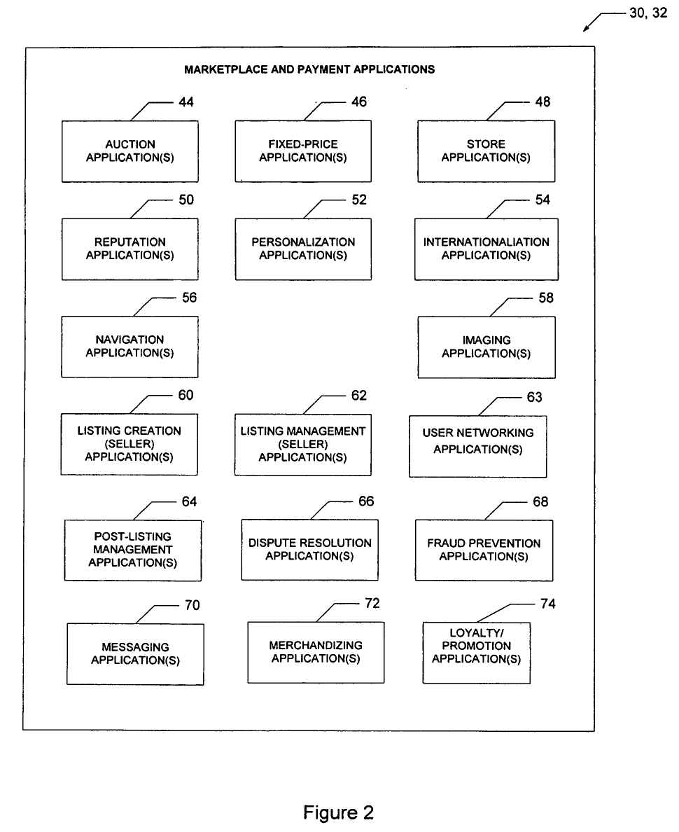

FIG. 2 is a block diagram illustrating multiple marketplace and payment applications 30 and 32, respectively, that are provided as part of the network-based marketplace 12, according to one exemplary embodiment of the present invention. The marketplace 12 may provide a number of listing and price-setting mechanisms whereby a seller may list goods and/or services (e.g. for sale), a buyer can express interest in or indicate a desire to purchase such goods and/or services, and a price can be set for a transaction pertaining to the goods and/or services. To this end, the marketplace and payment applications 30 and 32, respectively, are shown to include one or more auction applications 44 which support auction-format listing and price setting mechanisms (e.g., English, Dutch, Vickrey, Chinese, Double, Reverse auctions, Private auctions, etc.). The various auction applications 44 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 46 may support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with an auction-format listing, and allow a buyer to purchase goods and/or services, which are also being offered for sale via an auction, for a fixed-price that is typically higher than the starting price of the auction.

Store applications 48 may allow sellers to group their listings (e.g., goods and/or services) within a “virtual” store, which may be branded and otherwise personalized by and for the sellers. Such a virtual store may also offer promotions, incentives and features that are specific and personalized to a relevant seller. In one embodiment of the invention, the listings and/or transactions associated with the virtual store and its features may be provided to a targeted group of users having an existing relationship or association with the seller. An existing relationship or association may include a friend or family relationship, a transactional relationship (e.g., prior sales with user), or an overall network community relationship (e.g., buyers historical transaction rating).

Reputation applications 50 may allow parties that transact utilizing the network-based marketplace 12 to establish, build and maintain reputations, which may be made available and published to potential trading partners. Consider that where, for example, the network-based marketplace 12 supports person-to-person trading, users may have no history or other reference information whereby the trustworthiness and/or credibility of potential trading partners may be assessed. The reputation applications 50 may allow a user, for example through feedback provided by other transaction partners, to establish a reputation within the network-based marketplace 12 over time. Other potential trading partners may then reference such a reputation for the purposes of assessing credibility, trustworthiness, or the like.

Personalization applications 52 allow users of the marketplace 12 to personalize various aspects of their interactions with the marketplace 12. For example a user may, utilizing an appropriate personalization application 52, create a personalized reference page at which information regarding transactions to which the user is (or has been) a party may be viewed. Further, a personalization application 52 may enable a user to personalize listings and other aspects of their interactions with the marketplace 12 and other parties/users.

In one embodiment, the network-based marketplace 12 may support a number of marketplaces that are customized, for example, for specific geographic regions. A version of the marketplace 12 may be customized for the United Kingdom, whereas another version of the marketplace 12 may be customized for the United States. Each of these versions may operate as an independent marketplace, or may be customized (or internationalized) presentations of a common underlying marketplace. To this end, one or more internationalization applications 54 may be provided.

Navigation of the network-based marketplace 12 may be facilitated by one or more navigation applications 56. For example, a search application may, inter alia, enable key word searches of listings published via the marketplace 12. A browse application may allow users to browse various category, catalogue, or inventory data structures according to which listings may be classified within the marketplace 12. Various other navigation applications may be provided to supplement the search and browsing applications.

In order to make listings, available via the network-based marketplace 12, as visually informing and attractive as possible, the marketplace applications 30 may include one or more imaging applications 58 from which users may upload images for inclusion within listings. The imaging applications 58 may also operate to incorporate images within viewed listings. The imaging applications 58 may also support one or more promotional features, such as image galleries that are presented to potential buyers. For example, sellers may pay an additional fee to have an image included within a gallery of images for promoted items.

Listing creation applications 60 may allow sellers conveniently to author listings pertaining to goods and/or services that they wish to transact via the marketplace 12, and listing management applications 62 may allow sellers to manage such listings. Specifically, in one exemplary embodiment where a particular seller has authored and/or published a large number of listings, the management of such listings may present a challenge. The listing management applications 62 may provide a number of features (e.g., auto-relisting, inventory level monitors, etc.) to assist the seller in managing such listings.

In one embodiment, a seller may wish to customize a transaction/listing by exclusively providing transaction/listing details via the network-based marketplace 12 to a target group of users of the network-based commerce system that have a relationship or association with the seller. Accordingly, the listing creation applications 60 and listing management applications 62 may be used in conjunction with user networking applications 63 to customize the seller's listing. The relationship or association between any two parties/users/members of the networked-based marketplace 12 may be a direct relationship, or an indirect relationship that may be by virtue of relationships between one or more intermediate parties.

One or more post-listing management applications 64 may also assist sellers with a number of activities that typically occur post-listing. For example, upon completion of an auction facilitated by one or more auction applications 44, a seller may wish to leave feedback regarding a particular buyer. To this end, the post-listing management applications 64 may provide a link to one or more reputation applications 50, so as to allow the seller conveniently to provide feedback to the reputation applications 50 regarding the buyer. In another embodiment, the post-listing management application 64 may provide a link to the user networking applications 63 to allow the seller to view relationships and/or connections with each user of the targeted group. The post-listing management application 64 may further allow the seller to contact those users having a relationship with the seller during the pending transaction (e.g., during the auction) or after the completion of the transaction.

Dispute resolution applications 66 may provide mechanisms whereby disputes arising between transacting parties may be resolved. For example, the dispute resolution applications 66 may provide guided procedures whereby the parties are guided through a number of steps in an attempt to settle a dispute. In the event that the dispute cannot be settled via the guided procedures, the dispute may be escalated to a third party mediator or arbitrator. In one embodiment, the dispute resolution applications 66 may provide a link to the user networking applications 63 that allows the seller to view the relationship and/or connection between the seller and the user or users that participated in the transaction. For example, if a user that participated has an indirect relationship (e.g., a friend of the seller's friend), then the dispute resolution applications 66 may provide an interface to inform the direct relationship (seller's friend) of the dispute with the indirect relationship to facilitate a resolution.

A number of fraud prevention applications 68 may implement various fraud detection and prevention mechanisms to reduce the occurrence of fraud within the marketplace 12. In one embodiment, the fraud prevention applications 68 may communicate to each user of the target group their respective relationship to the seller (which may be referred to as a first user). Each targeted user understanding their relationship (e.g., indirect relationship) to the seller may assist in preventing fraud and/or other undesirable actions because each user of the target group may have to answer to the seller directly or to an intermediate user or users which share a direct relationship with the seller.

Messaging applications 70 may be responsible for the generation and delivery of messages to users of the network-based marketplace 12, such messages for example advising users regarding the status of listings at the marketplace 12 (e.g., providing “outbid” notices to bidders during an auction process or to provide promotional and/or merchandising information/advertising to users). In one embodiment, the messaging applications 70 may be used in conjunction with the user networking applications 63 to provide promotional and/or marketing to targeted users that share a relationship or connection with the seller.

In another embodiment, the messaging applications 70 may provide an alert to the seller or bidders indicating an existence of a relationship with one or more of the other bidders. In one example, a bidder may receive a message indicating a friend (a direct relationship) or a friend of a friend (an indirect relationship) is also bidding on the same item. At which point, the bidder may elect to withdraw from bidding or optionally contact the relationship to discuss the bid. In another example, a seller may choose to sell/auction an item to the general community (non-targeted) and may receive a message indicating a friend (a direct relationship), a friend of a friend (an indirect relationship), a transactional relationship (e.g., prior sales with user), or an overall network community relationship (e.g., buyers historical transaction rating) is bidding on their item. In response, the seller may contact that relationship and offer preferred treatment, such as a discount for buying now, option to buy now, right of first refusal, payment options, and/or preferred shipping. The buyer may also allow preferred treatment for the seller with whom a relationship exists, such as relaxing the terms of the transaction contract by, for example, allowing the seller additional time to ship the item.

Merchandising applications 72 may support various merchandising functions that are made available to sellers to enable sellers to increase sales via the marketplace 12. The merchandising applications 80 may also operate the various merchandising features that may be invoked by sellers, and may monitor and track the success of merchandising strategies employed by sellers.

The network-based marketplace 12 itself, or one or more parties that transact via the marketplace 12, may operate loyalty programs that are supported by one or more loyalty/promotions applications 74. For example, a buyer may earn loyalty or promotions points for each transaction established and/or concluded with a particular seller, and may be offered a reward for which accumulated loyalty points can be redeemed.

It will be appreciated that one or more the various exemplary marketplace and payment applications 30, 32 may be combined into a single application. Further, in some embodiments of the inventions one or more applications may be omitted and additional applications may also be included.

Data Structures

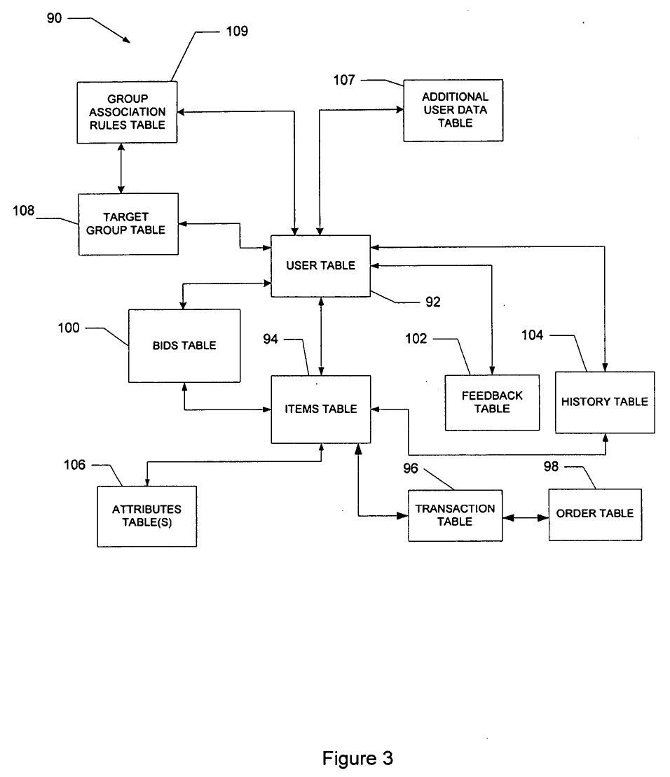

FIG. 3 is a high-level entity-relationship diagram, in accordance with an exemplary embodiment, illustrating various tables 90 that may be maintained within the databases 36 (see FIG. 1), and that are utilized by and support the marketplace and payment applications 30 and 32. A user table 92 may contain a record for each registered user of the network-based marketplace 12, and may include identifier, address and financial instrument information pertaining to each such registered user. A user may operate as a seller, a buyer, or both, within the network-based marketplace 12. In one exemplary embodiment of the present invention, a buyer may be a user that has accumulated value (e.g., commercial or proprietary currency), and is then able to exchange the accumulated value for items that are offered for sale by the network-based marketplace 12.

The tables 90 may also include an items table 94 in which are maintained listing or item records for goods and/or services that are available to be, or have been, transacted via the marketplace 12. Each listing or item record within the items table 94 may furthermore be linked to one or more user records within the user table 92, so as to associate a seller and one or more actual or potential buyers with each item record.

A transaction table 96 may contain a record for each transaction (e.g., a purchase transaction) pertaining to items or listings for which records exist within the items table 94.

An order table 98 may be populated with order records, each order record being associated with an order. Each order, in turn, may be with respect to one or more transactions for which records exist within the transactions table 96.

Bid records within a bids table 100 may each relate to a bid received at the network-based marketplace 12 in connection with an auction-format listing supported by the auction applications 44. In one exemplary embodiment, a feedback table 102 may be utilized by one or more of the reputation applications 50 to construct and maintain reputation information associated with users. A history table 104 may maintain a history of transactions to which a user has been a party.

One or more attributes tables 106 may record attribute information pertaining to items or listings for which records exist within the items table 94. Considering only a single example of such an attribute, the attributes tables 106 may indicate a currency attribute associated with a particular item, the currency attribute identifying the currency of a price for the relevant item or listing as specified in by a seller.

Additional user data table 107 may contain additional user data supplied by each user or derived from other data tables. The additional user data table 107 may be stored under pre-defined categories or may be stored within user-defined categories. For example, a user may supply data that may be unique to that user or common to many users, such as favorite shopping category (e.g., clothes), color(s), pet(s), movie(s), actor(s), supply multimedia (e.g., picture or sound files), interests, or other data. The marketplace applications 30 may also be configured to derive a portion of the additional user data. For example, a user's shopping preferences may be derived based on past purchases within the marketplace by processing user history data. It will be appreciated that the data associated with the user data table 107 may also be located in user table 92. Further examples of user data and categories will be discussed below.

Group(s) of users found in a target group table 108 may be targeted group(s) of users selected for a possible transaction(s) by a first user that has an existing relationship with each targeted user. The targeted group(s) may be a result of the first user selecting a group association rule that results in a filtering process of all users having a relationship with the first user. The existing relationships may be defined in part by the group association rules or vice versa. An existing relationship or association may include a friend or family relationship, a transactional relationship (e.g., prior sales with user), a common interest relationship (e.g., all users that like motorcycles), or an overall network community relationship (e.g., buyers historical transaction rating). For example, an existing relationship may include social networking parameters, such as direct relationships that include users that are the seller's friends or indirect relationships, such as friends of the user's friends. In another example, a user may wish to target those users in the community that share at least one common interest, such as those users that like alternative music, motorcycles, and opera, or any combination thereof. These types of interests are examples of data that may be found in the additional user data table 107 described above.

In one embodiment, the group association rules are predetermined and stored in a group association rules table 109. In another embodiment, the first user creates a custom group association rule that may be stored in the group association rules table 109 and associated with the first user or made available to other users. The group association rules may include social networking parameters that represent a relationship diagram of a social network within the network-based marketplace. The user or the system may determine how many levels, or degrees, the relationship or association may extend (levels of users accessible by the first user) in generating target groups through group association rules. For example, a first level may be at least one friend, a second level may be friends of the friend, a third level may be friends of the friends of the friend, and so on. It will be appreciated that the relationship or association need not be limited to friendship, which is used merely by way of example.

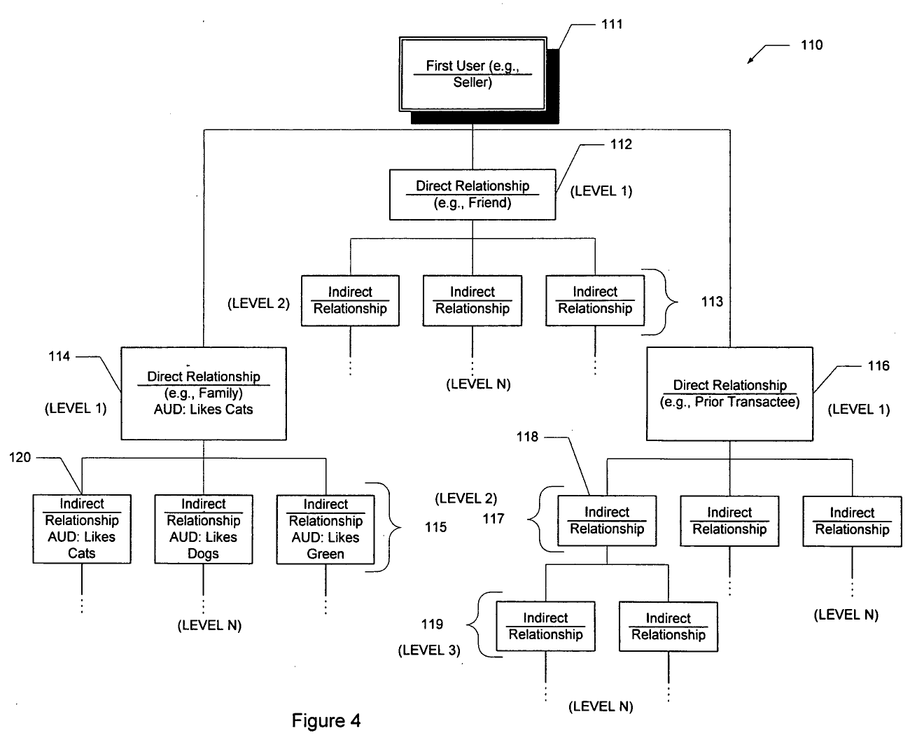

FIG. 4 illustrates an exemplary embodiment of a relationship diagram 110 including levels of association or relatedness (1, 2, 3 . . . N) to a first user 111. The first user 111 may have various types of direct relationships (first level), such as a friend 112, family 114 and prior transactee 116 (e.g., a user with whom the first user has previously conducted a transaction). In addition, the first user may have one or more indirect relationships (second level) with other users via one or more the direct relationships. The second level indirect relationships may have a direct relationship with the first level relationships and with third level relationships. In other words, the indirect relationships 113, 115, and 117 are indirectly associated with the first user 111 through known intermediaries, which, in the present exemplary embodiment, are the direct relationships 112, 114, and 116. Additionally, indirect relationships may also be intermediaries in a transaction. For example, an indirect relationship 118 and direct relationship 116 may be intermediaries between the first user 111 and indirect relationships 119 (third level). In varying embodiments, the maximum number of direct and/or indirect relationships allowed to be intermediaries in a transaction may be limited by the network-based marketplace 12 or the first user 111. It will thus be appreciated that a target group of users may thus be defined where a first user is associated or linked to a plurality of target users based on a series of direct relationships. In other words, in one embodiment, each level of association may be linked to an adjacent level by a direct relationship. The direct relationships may define trusted relationships, which the first user may then rely on.

In one embodiment, the group association rules may determine what target group is generated based on the relationship diagram 110. For example, the first user 111 may select two group association rules to target, 1) family and 2) friends of the family. This may correspond to the direct relationship 114 and the indirect relationships 115. Therefore, the target group generated to participate in the transaction may only be the users corresponding to these two levels. As discussed above, in various embodiments the transaction may be, among others, a private or semi-private auction sale, fixed-price sale, message (e.g., advertisement, etc.), or other type of communication between users associated with the network-based marketplace 12. For example, a message may be specific advertisements directed to a selected target group having or sharing a particular characteristic related to the advertisement. Additionally, a private auction may be between only the first user and a single other user, while a semi-private auction may be between the first user and a selected group of users.

In another embodiment, a group association rule may include personal data from the additional user data table 107. For example the first user may only wish to target, 1) members of their family that like cats and 2) friends of their family that like cats. This group association rule selection would correspond to a target group that includes the direct relationship 114 (family) and the indirect relationship 120 (friends of family), each of which likes cats. The first user then may send a message marketing cat products to only the users of that selected group. It should be noted that these embodiments including these specific group association rules are only exemplarily and it will be appreciated that the selected group association rules may be based upon many types of stored data associated with each targeted user.

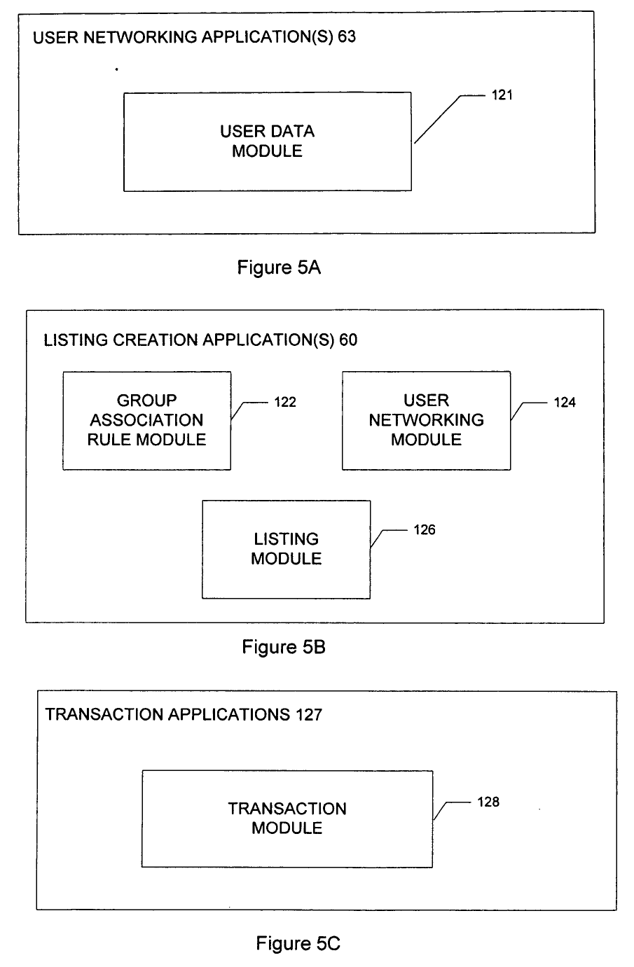

FIGS. 5A, 5B, and 5C provide exemplary functional modules of the applications of FIG. 2. It will be appreciated that the applications and associated modules may be executed within any portion of the system 10 (e.g., the client machine 20 and/or the network-based marketplace 12). FIG. 5A illustrates the user networking applications 63, which includes a user data module 121 for collecting additional user data. In one embodiment, user data module 121 processes additional user data entered from a user interface supplied by the user networking application 63. The processing may include parsing the additional user data into predefined categories, dependent upon predefined parameters or characteristics, which is then stored in the additional user data table 107. For example, a user may supply additional personal information by filling out a web form containing fields for inputting such preferences as favorite color, pet, automobile, movie, etc. Further, these categories may also include interests like rock climbing, racquetball, knitting, horticulture, etc. These preferences and/or interests may then be stored under main categories and/or categories of the same name (e.g., sports/rock climbing or favorite color). In another embodiment, a user may create a custom category to upload to the database, such as favorite brand of soap or furniture wax.

In another embodiment, the user data module 121 may derive a portion of the additional user data from any of the tables shown in FIG. 3. For example, the user data module 121 may derive a user's shopping preferences by processing user history data, such as past purchases of automobiles within the network-based marketplace 12, from history table 104. This data may then be stored in the subcategory, “automobiles” under a main category of “past purchases.”

FIG. 5B illustrates an exemplary embodiment of the listing creation application 60. The listing creation application 60 is shown to include a group association rule module 122, a user networking module 124, and a listing module 126. In one embodiment, a first user may select a group association rule from a user interface provided by the listing creation application 60 to generate a listing to be provided to a targeted group of users that are related to, or associated with by virtue of the association rule, the first user. The group association rule module 122 may interact with the group association rules table 109 to provide a selectable set of group association rules for the first user to select from within the user interface. The group association rule module 122 may further derive a portion of the group association rules by analyzing additional user data (e.g., favorite color) gathered by the user data module 121. Thus, in one embodiment, one or more association rules can be used to identify a group of users.

The user networking module 124 may process user data from the user table 92 according to at least one group association rule selected by the first user via the group association rule module 122. For example, the first user may want to list to a target group of users with which the user previously transacted (a first group association rule) and that have purchased from a specific category, such as automobiles (a second group association rule). It will be appreciated that multiple association rules may be selected the user. In one embodiment, the user networking module 124 may apply the first group association rule, all users that have transacted with the first user, to obtain a first group of users, then apply the second group association rule, all users that have purchased automobiles, to the first group of users to generate a target group of users that may be stored in the target group table 108. The listing module 126 may then generate and distribute the list to the target group of users through the network-based marketplace 12 and the network 14. It will be appreciated that parsing or sorting user data according to a search rule may be performed by one of many known techniques in the art, such as generating and processing an SQL (Structured Query Language) search string.

In another embodiment, the user networking module 124 may also utilize the messaging applications 70 to generate a message to at least one targeted user indicating that an existing relationship exists with others of the targeted group. For example, the targeted user may receive a message indicating a friend (a direct relationship) or a friend of a friend (an indirect relationship) is also bidding on the same item. Any or all of the targeted users receiving such a message may elect to withdraw from the bidding or group, or optionally contact the relationship to discuss the item and/or possible transaction.

FIG. 5C illustrates an exemplary embodiment of a transaction applications 127, according to an exemplary embodiment of the invention, which includes a transaction module 128 to facilitate transactions between users. In various embodiments, the transaction applications 127 may include any and all of the applications shown in FIG. 2 that may be used to facilitate transactions between users. As discussed above, a transaction may be established using a private or semi-private auction sale, fixed-price sale, marketing message, or other type of communication between users associated with the network-based marketplace 12. For example, the transaction module 128 may facilitate the dissemination of marketing material pertaining to a first user's product to a targeted group of users wherein each of those users has an existing relationship or association with the first user. In another embodiment, the transaction module 128 may facilitate an auction sale between the first user and any or all of the users of the targeted group. In yet another embodiment, the transaction module 128 may facilitate a sale when the seller (first user) agrees to sell to at least one user based on a message received that the at least one user bidding in a non-targeted auction has an existing relationship with the seller.

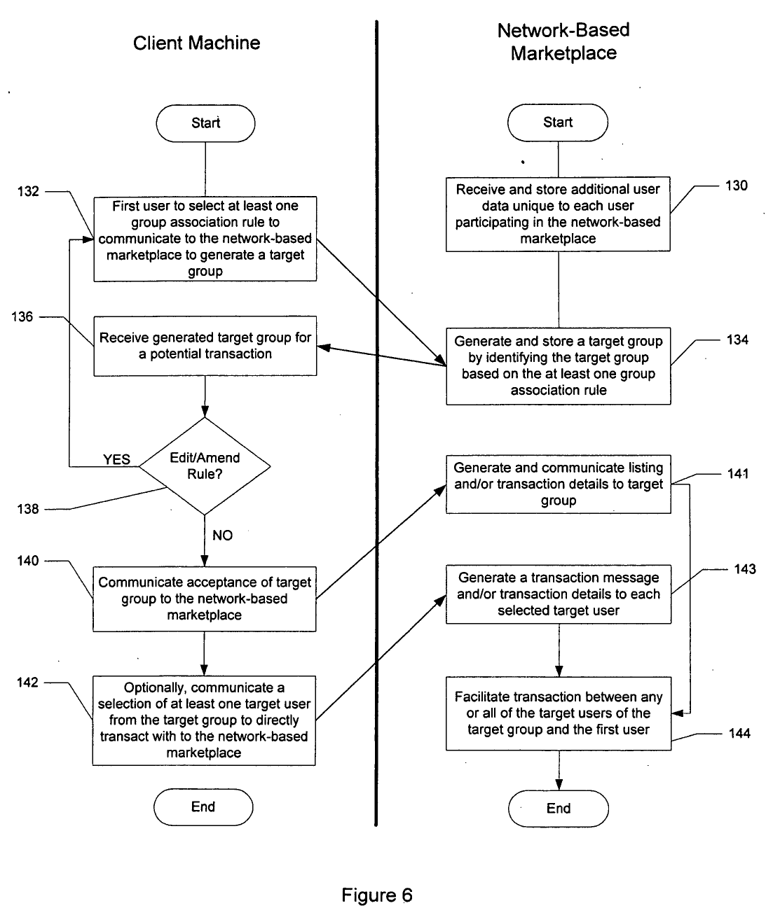

FIG. 6 is an interactive flowchart illustrating the process, according to one embodiment of the invention, of generating a target group associated with, for example, the network-based marketplace 12 based upon at least one group association rule. The network-based marketplace 12 may include user data, such as the user data stored in user table 92. Additionally, the network-based marketplace 12, at operation 130, may receive and store additional user data that may be unique to each user participating in the network-based marketplace 12. This additional user data may be stored in a data table of the database 36, such as the additional user data table 107. The additional user data may be used in conjunction with a group association rule to filter and thereafter generate a target group. For example, at operation 132, a first user may select at least one group association rule to define a target group of users for a potential transaction or listing, wherein each user of the target group has an existing relationship or association with the first user (e.g., designated friend in marketplace 12). At operation 134, the network-based marketplace 12 may generate and store a target group by processing the at least one group association rule received from the client machine 20. The client machine 20 may receive the generated target group for the possible transaction or listing, at operation 136, and decide based on the generated target group (see operation 138) whether to edit the group association rule and resubmit it to the network-based marketplace 12 or communicate acceptance of the target group to the network-based marketplace 12 at operation 140. Thus, in one embodiment, the marketplace 12 may provide one or more predefined group association rules that a user may edit or customize. At operation 141, the network-based marketplace 12 may generate and communicate a listing and/or transaction details to the target group. The network-based marketplace 12 may then facilitate any transactions between any or all of the target users and the first user (operation 144).

In another embodiment, the first user at operation 142, may have the option of transacting directly with at least one of the targeted users. For example, the first user may want to offer a discount or direct sale to those targeted users that have particular characteristics based upon data found in data tables such as user table 92, history table 104, feedback table 102, and additional user data table 107. For example, the first user may want to offer a discount to those of the targeted users that are dog lovers as indicated to the first user through a user interface communicatively coupled to the additional user data table 107 of network-based marketplace 12. At operation 143, the network-based marketplace 12 may generate and communicate a transaction message and/or transaction details to each selected targeted user of the target group. The network-based marketplace 12 may then facilitate any transactions between any or all of the target users and the first user (operation 144).

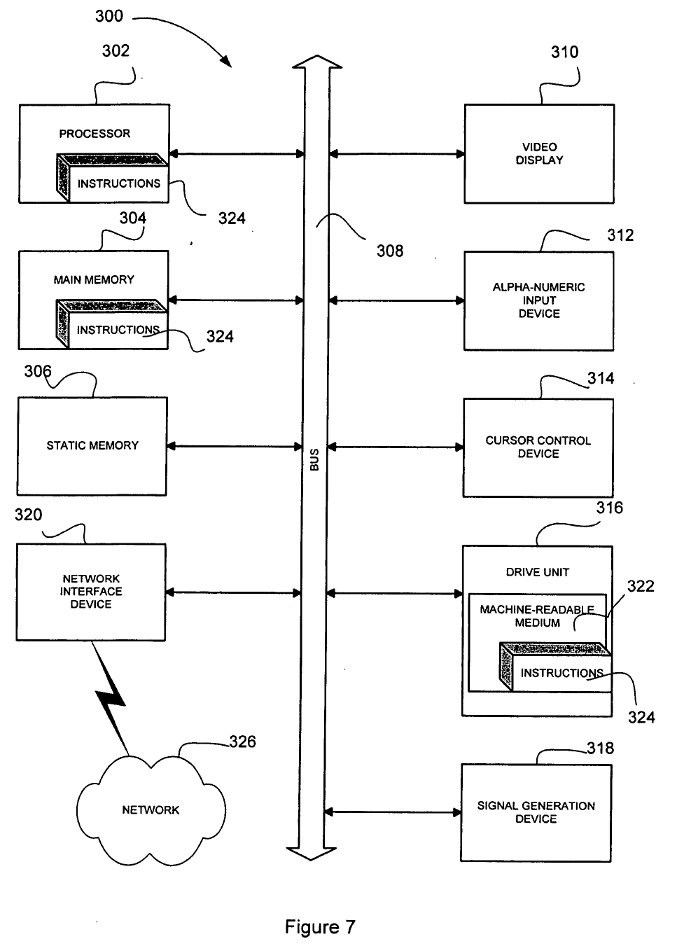

FIG. 7 shows a diagrammatic representation of machine in the exemplary form of a computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processor 302 (e.g., a central processing unit (CPU) a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a cursor control device 314 (e.g., a mouse), a disk drive unit 316, a signal generation device 318 (e.g., a speaker) and a network interface device 320.

The disk drive unit 316 includes a machine-readable medium 322 on which is stored one or more sets of instructions (e.g., software 324) embodying any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media.

The software 324 may further be transmitted or received over a network 326 via the network interface device 320.

While the machine-readable medium 322 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to utilize a user network within a network-based commerce platform have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A system to facilitate a transaction in a network-based commerce system, the system including:
a group association rule module to identify a target group including at least one other user of the network-based commerce system, the identification being based on at least one group association rule selectable by a first user;
a listing module to distribute transaction information to the identified target group; and
a transaction module to facilitate the transaction between at least one target user of the identified target group and the first user, wherein the first user and the identified target group have an existing relationship.

2. The system of claim 1, wherein the at least one group association rule pertains to a level of association of the first user to other users of the network-based commerce system.

3. The system of claim 2, wherein a first level corresponds to a direct relationship to the first user and subsequent levels correspond to indirect relationships with the first user.

4. The system of claim 1, wherein the transaction is a purchase transaction.

5. The system of claim 4, wherein a purchase price for the purchase transaction is established using one of a private auction and a semi-private auction with the target group.

6. The system of claim 1, wherein the transaction is a message communicated to the target group.

7. The system of claim 6, wherein the message is a marketing message.

8. The system of claim 1, wherein the at least one group association rule relates to data pertaining to each user of the target group.

9. The system of claim 8, wherein the data relates to at least one user of the target group having a direct relationship with the first user.

10. The system of claim 8, wherein the data relates to an indirect relationship, wherein at least one other user is an intermediary between the indirect relationship and the first user.

11. The system of claim 10, wherein the intermediary is the direct relationship.

12. The system of claim 8, wherein the data includes at least one of history data, feedback data, and additional user data relating to a prior transaction conducted via the network-based commerce system.

13. The system of claim 12, wherein the history data includes data pertaining to all users that had previous transactions with the first user.

14. The system of claim 12, wherein the feedback data associated with each targeted user includes feedback from other users pertaining to each targeted user.

15. The system of claim 12, wherein the additional user data includes at least one of family relationship data and personal data associated with each targeted user.

16. The system of claim 12, wherein the first user selects the at least one target user for the facilitated transaction based upon the data pertaining to each user of the target group.

17. The system of claim 16, wherein the first user provides a discount to the at least one selected target user.

18. The system of claim 1, wherein the group association rule module is to sort the identified target group based on at least one second group association rule.

19. The system of claim 1, including a user data module to receive additional user data from users of the network-based commerce system prior to the group association rule module identifying the target group, the additional user data including at least one of data unique to each user and data common to each user.

20. The system of claim 19, wherein the user data module is to store the additional user data into categories.

21. The system of claim 20, wherein the categories include at least one of personal information, interests, multimedia items, and listing preferences.

22. The system of claim 1, including a user networking module to provide a message to each targeted user that an existing relationship exists with other targeted users of the identified target group.

23. The system of claim 22, wherein the user networking module is further to facilitate communications between target users having the existing relationship.

24. The system of claim 1, wherein the existing relationship includes at least one of a direct relationship, an indirect relationship, a transactional relationship, a common interest relationship, and an overall network community relationship.

25. A method of facilitating a transaction in a network-based commerce system, the method including:
identifying a target group including at least one other user of the network-based commerce system based on at least one group association rule, the at least one group association rule being selected by a first user;
communicating transaction information to the identified target group; and
facilitating the transaction between at least one target user of the identified target group and the first user, wherein the first user and the identified target group have an existing relationship.

26. The method of claim 25, wherein the transaction is a purchase transaction.

27. The method of claim 26, wherein a purchase price for the purchase transaction is established using one of a private auction and a semi-private auction with the target group.

28. The method of claim 25, wherein a first level corresponds to a direct relationship to the first user and subsequent levels correspond to indirect relationships with the first user.

29. The method of claim 27, wherein the transaction is one of a private auction and a semi-private auction with the target group.

30. The method of claim 29, wherein the transaction is a message communicated to the target group.

31. The method of claim 29, wherein the message is a marketing message.

32. The method of claim 25, wherein the at least one group association rule relates to data pertaining to each user of the targeted group.

33. The method of claim 32, wherein the data relates at least one user of the target group having a direct relationship with the first user.

34. The method of claim 32, wherein the data relates to an indirect relationship, wherein at least one other user is an intermediary between the indirect relationship and the first user.

35. The method of 34, wherein the intermediary is the direct relationship.

36. The method of claim 32, wherein the data includes at least one of history data, feedback data, and additional user data relating to a prior transaction conducted via the network-based commerce system.

37. The method of claim 36, wherein the history data includes data pertaining to all users that had previous transactions with the first user.

38. The method of claim 37, wherein the feedback data associated with each targeted user includes feedback from other users pertaining to each targeted user.

39. The method of claim 36, wherein the additional user data includes at least one of family relationship data and personal data associated with each targeted user.

40. The method of claim 36, including the first user selecting the at least one target user for the facilitated transaction based upon the data pertaining to each user of the target group.

41. The method of claim 40, including the first user providing a discount to the at least one selected target user.

42. The method of claim 25, which includes prior to the facilitating the transaction, sorting the identified target group based on at least one second group association rule.

43. The method of claim 25, which includes prior to the identifying the target group, receiving additional user data from users of the network-based commerce system, the additional user data including at least one of data unique to each user and data common to each user.

44. The method of claim 43, which includes storing the additional user data into at least one of predefined and user-defined categories.

45. The method of claim 44, wherein the categories include at least one of personal information, interests, multimedia items, and listing preferences.

46. The method of claim 43, which includes providing each user with a user interface for user data entry.

47. The method of claim 46, wherein each user interface includes at least one of a predefined category and a user definable category.

48. The method of claim 25, which includes providing a message to each targeted user indicating an existing relationship exists with other targeted users of the identified target group.

49. The method of claim 48, which includes facilitating communications between targeted users having the existing relationship.

50. The method of claim 25, wherein the existing relationship includes at least one of a direct relationship, an indirect relationship, a transactional relationship, a common interest relationship, and an overall network community relationship.

51. A means of facilitating a network-based transaction utilizing social networking within a network-based commerce platform, the means including:
means for identifying a target group including at least one other user of the network-based commerce system based on at least one group association rule, the at least one group association rule being selected by a first user;
means for communicating transaction information to the identified target group; and
means for facilitating the transaction between at least one target user of the identified target group and the first user, wherein the first user and the identified target group have an existing relationship.

52. The means of claim 51, which includes means for sorting the identified target group based on at least one second group association rule, prior to the facilitating the transaction.

53. The means of claim 51, which includes means for receiving additional user data from users of the network-based commerce system prior to the identifying the target group, the additional user data including at least one of data unique to each user and data common to each user.

54. The means of claim 53, which includes means for storing the additional user data into at least one of predefined and user-definable categories.

55. The means of claim 51, wherein the at least one group association rule pertains to a level of relatedness of the first user to other users of the network-based commerce system.

56. The means of claim 55, wherein a first level corresponds to a direct relationship to the first user and subsequent levels correspond to indirect relationships with the first user.

57. A machine-accessible medium that provides instructions that, if executed by a machine, will cause the machine to perform operations including:
identifying a target group including at least one other user of the network-based commerce system based on at least one group association rule, the at least one group association rule being selected by a first user;
communicating transaction information to the identified target group; and
facilitating the transaction between at least one target user of the identified target group and the first user, wherein the first user and the identified target group have an existing relationship.

58. The machine-accessible medium of claim 57, wherein the operations include sorting the identified target group based on at least one second group association rule prior to the facilitating the transaction.

59. The machine-accessible medium of claim 57, wherein the operations include receiving additional user data from users of the network-based commerce system prior to the identifying the target group, the additional user data including at least one of data unique to each user and data common to each user.

60. The machine-accessible medium of claim 59, wherein the operations include storing the additional user data into at least one of predefined and user-definable categories.

61. The machine-accessible medium of claim 57, wherein the at least one group association rule pertains to a level of relatedness of the first user to other users of the network-based commerce system.

62. The machine-accessible medium of claim 61, wherein a first level corresponds to a direct relationship to the first user and subsequent levels correspond to indirect relationships with the first user.
